(19) United States
(12) Patent Application Publication
(10) Pub. No.: US 2009/0164869 A1
(43) Pub. Date: Jun. 25, 2009

(54) MEMORY ARCHITECTURE AND CONFIGURATION METHOD THEREOF

(75) Inventor: Yi-Hsien Chuang, Hsinchu (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 12/108,787

(22) Filed: Apr. 24, 2008

(30) Foreign Application Priority Data
Dec. 21, 2007 (TW) 96149285

(51) Int. Cl. G06F 11/10

(52) U.S. Cl. 714/763; 714/E11.032

(57) ABSTRACT

A memory architecture and a configuration method thereof are provided. In the memory configuration method, a data to be stored in the memory and a corresponding error correction code (ECC) are first provided. When the data is written into the memory, the ECC is stored next to the corresponding data, such that the ECC and the corresponding data can be adjoined with each other in the memory. As a result, when the data is read from the memory, the data and the corresponding ECC can be obtained in turn, so as to achieve the purpose of checking the correctness of the data with a smaller buffer, and the hardware cost of the buffer can also be reduced.

### CROSS-REFERENCE TO RELATED APPLICATION

This application claims the priority benefit of Taiwan application serial no. 96149285, filed on Dec. 21, 2007. The entirety of the above-mentioned patent application is hereby incorporated by reference herein and made a part of specification.

### BACKGROUND OF THE INVENTION

1. Field of the Invention

The present invention relates to a memory architecture and a configuration method thereof. More particularly, the present invention relates to a memory architecture and a configuration method thereof, in which relatively small buffer space is required during accessing memory data.

2. Description of Related Art

With development of technology, non-volatile memories such as flash memories have become one of main storage medias. Generally, the flash memories are grouped into program flash memories and data flash memories according to functions thereof. Wherein, an NAND flash with features of low cost and capable of fast reading continuous large-volume data is especially suitable for storing data.

A page is the smallest storage unit within the NAND flash, and each storage block includes a plurality of pages. Generally, the NAND flash includes a plurality of the storage blocks. FIG. 1 is a schematic diagram illustrating an internal data configuration of a conventional NAND flash. Referring to FIG. 1, in a general NAND flash structure, each page includes a data storage space 110 with a size of 512 bytes, and an auxiliary space 120 with a size of 16 bytes. Wherein, the data storage space 110 may further be divided into a first data storage area and a second data storage area respectively with a size of 256 bytes. The auxiliary space 120 not only stores information such as a block damage mark and a logic address of the storage block corresponding to the page, the most important is that the auxiliary space 120 may store an error correction code (ECC) corresponding to the stored data. In accordance with a limitation of utilization life time of the NAND flash, correctness of the data may be checked via the ECC during accessing of the NAND flash, so as to prevent occurring of data error or correct the occurred data error.

Since the page is the minimum unit to be read during data reading of the NAND flash (i.e. each time one page of data has to be read), a buffer space with 512 bytes has to be provided to store the data stored in the data storage space 110. Therefore, when an ECC stored in a second ECC area 121 is read, the data originally stored in the second data storage area then may be obtained from the buffer space, so as to compare the data to the ECC. Thereafter, when an ECC stored in a first ECC area 123 is read, the data originally stored within the first data storage area is then obtained from the buffer space, so as to compare the data to the corresponding ECC.

However, in another type of novel NAND flash, the data storage space of each page is improved from 512 bytes to 2048 bytes, and therefore the corresponding auxiliary space is increased to 64 bytes. Similar to the internal data configuration of the NAND flash of FIG. 1, in the novel NAND flash, each page is also composed a data storage space and an auxiliary space, wherein 2048 bytes are used for storing data, and 64 bytes are used for storing the corresponding block damage mark, the logic address of the storage block and the ECC etc. Similarly, during read operation of the novel NAND flash, a buffer space with a size matching to the size of the storage space (i.e. 2048 bytes) has to be provided for temporarily storing data, such that when the ECC is read, the data stored in the buffer space may be obtained for being compared to the ECC. Namely, with variation of the NAND flash architecture, the greater the storage space of each page is, the greater the buffer space is required during data reading.

Moreover, the page is also the minimum programmable unit of the NAND flash. Before programming one page, the entire storage block relative to the page has to be erased. Since the storage block is the minimum erasable unit, when data stored in a page of a certain storage block is about to be renewed, an erased storage block is first prepared. Next, the data to be renewed is written into a new storage block according to an address of the page within an old storage block. Finally, other data stored within the old storage block is sequentially copied to the other pages within the new storage block. Therefore, not only extra time is required for relocating the data, but also a problem of inconsistency of addresses of the storage block may occur. To correctly record the address of the new storage block after the data being renewed, an extra storage space (such as a SRAM) is required for storing a mapping table of a logical address and a physical address of each storage block.

In summary, increasing of the buffer space of the NAND flash and the required storage space for storing the address mapping table all have a negative influence to the cost of the hardware required for storing data.

### SUMMARY OF THE INVENTION

Accordingly, the present invention is directed to a memory configuration method, by which an error correction code (ECC) and a corresponding data may be stored adjacent to each other, so as to improve convenience for checking correctness of the data during read operation.

The present invention is directed to a memory architecture, in which data and corresponding ECC may be adjacent to one another within the memory, so that after the data is read, the ECC may be immediately read to perform a checking operation thereof, so as to reduce a buffer space used for temporarily storing data and reduce a cost of hardware.

The present invention provides a memory configuration method for a memory having at least one storage block, wherein each storage block may store a plurality of data. First, an ECC corresponding to each data is provided. Next, each ECC is stored next to the corresponding data when the data is written into the memory.

According to an embodiment of the present invention, in the memory configuration method, size of each data matches a first predetermined value, and the step of providing the ECC corresponding to each data includes performing a specific calculation to each data to generate an ECC with a size matching a second predetermined value.

According to an embodiment of the present invention, the memory configuration method further includes recording a mapping relation of a logical address and a physical address of each storage block into the memory.

According to an embodiment of the present invention, the memory configuration method further includes providing a first logical address corresponding to one of the storage blocks, and providing a physical address of a specific storage block, wherein a second logical address corresponding to the specific storage block is adjacent to the first logical address. And the physical address is recorded into the memory.

According to an embodiment of the present invention, in the memory configuration method, when two continuous data are read, whether or not a second logical address of a storage block storing a second data is adjacent to a first logical address of a storage block storing a first data is first judged. If the second logical address is adjacent to the first logical address, a physical address recoded within the memory is then provided, and the provided physical address corresponds to the second logical address.

According to an embodiment of the present invention, the memory configuration method further includes providing a predetermined byte serial number corresponding to each reading unit. The data is divided and stored respectively into one of the reading unit if the address of storing the data comprises the predetermined byte serial number, so as to maintain an address corresponding to the predetermined byte serial number for storing a detection result of the reading unit.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram illustrating an internal data configuration of a conventional NAND flash.

FIG. 2 is a flowchart illustrating a memory configuration method according to an embodiment of the present invention.

FIG. 3 is a schematic diagram illustrating an internal data configuration of a memory according to the aforementioned configuration method.

FIG. 4 is a schematic diagram illustrating a page of an address mapping table block according to an embodiment of the present invention.

FIG. 5 is a schematic diagram illustrating an internal data configuration of a memory according to another embodiment of the present invention.

### DESCRIPTION OF EMBODIMENTS

When an NAND flash memory is used as a storage media, if sizes of buffer space required for reading data may be unified, utilization flexibility of the NAND flash may be improved. Furthermore, if a relatively small buffer space may be used for achieving the above object, fabrication cost of the storage media is then reduced. Accordingly, the present invention provides a memory architecture and a configuration method thereof based on the above aspect. To fully convey the spirit of the present invention, embodiments are provided below for describing the present invention in detail.

FIG. 2 is a flowchart illustrating a memory configuration method according to an embodiment of the present invention. In the present embodiment, the memory may be an NAND flash including a plurality of storage blocks, wherein each storage block is composed of specific number (for example 32) of pages for storing a plurality of data.

Referring to FIG. 2, in step 210, a data to be written into the memory is provided by a computer system, wherein size of the data matches a first predetermined value. Next, in step 220, a specific calculation is performed to the data to generate an error correction code (ECC) with a size matching a second predetermined value. Generally, length of the ECC relates to the size of the data. Taking a data with a size of 128 bytes as an example, the ECC with a size of 3 bytes is required, wherein 1 byte is for data correction and 2 bytes are for error detection. In the present embodiment, any calculation method relates to error detection and correction technique of the data may be used for calculating the ECC of the present invention, which is not limited by the present invention. Finally, in step 230, when the data is written into the memory, each ECC is stored adjacent to the corresponding data. For example, the ECC may be stored before the corresponding data. Alternatively, the ECC may also be stored next to the corresponding data, which are not limited by the present invention.

It should be noted that to solve the problem of address inconsistency between a logical address and a physical address of the storage block probably occurred during renewing of the data, a mapping relation of the logical address and the physical address of each storage block is further recorded into the NAND flash. Moreover, when data stored within the NAND flash is read, probably, a large amount of continuous data therein is also read (for example, when the storage block with the logical address of 1 is read, there has a great chance that the storage block with the logical address of 2 is also read), and therefore when the logical address of each storage block is recorded, a physical address of a storage block with a logical address thereof adjacent to the above logical address are simultaneously recorded, such that the physical address of a next storage block may be quickly found in case of the above situation, so as to continuously perform the read operation.

According to the above method, when the data is written into the memory, the data is stored next to the corresponding ECC within the memory. Thereafter, when the data is read from the memory, the ECC then may be immediately obtained after the data is read, and then the correctness of the data may be checked via calculation and comparison.

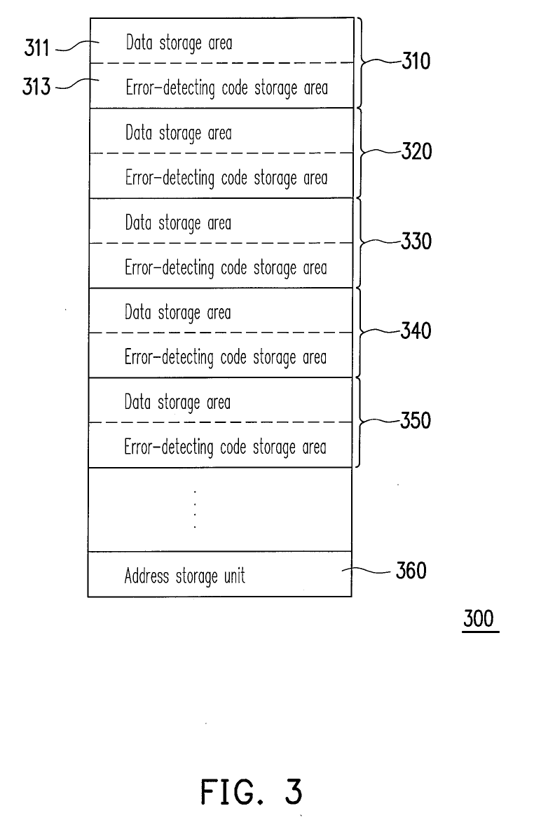

For convenience, in the following embodiment, assuming the ECC is stored behind the corresponding data when the data is written into the memory, and the configured NAND flash includes a plurality of the storage blocks, wherein each storage block is composed of a plurality of the pages. FIG. 3 is a schematic diagram illustrating a configuration of a page of an NAND flash according to the aforementioned configuration method. Referring to FIG. 3, in a page 300, each data storage area (for example a data storage area 311) with a size of the first predetermined value is used for storing data, and each error-detecting code storage area (for example an error-detecting code storage area 313) with a size of the second predetermined value is used for storing the ECC, wherein the ECC corresponds to the data stored in an adjacent data storage area. In the present embodiment, the adjacent data storage area and the error-detecting code storage area are collectively called as data storage unit (for example, data storage units 310˜350).

Based on the utilization feature of the NAND flash that each time a large amount of continuous data may be read from the NAND flash, an address storage unit 360 is then used for storing a physical address of a specific storage block. Wherein, a logical address of the specific storage block is located adjacent (for example, next to) to the logical address of the storage block where the page 300 is located. Accordingly, when a next data is read, whether or not the logical address of the storage block storing the next data is located adjacent to the logical address of the storage block where the page 300 is located is then judged. If the two addresses are located adjacent to each other, the physical address of the adjacent storage block then may be obtained directly from an address storage unit 360, so as to improve the data reading speed.

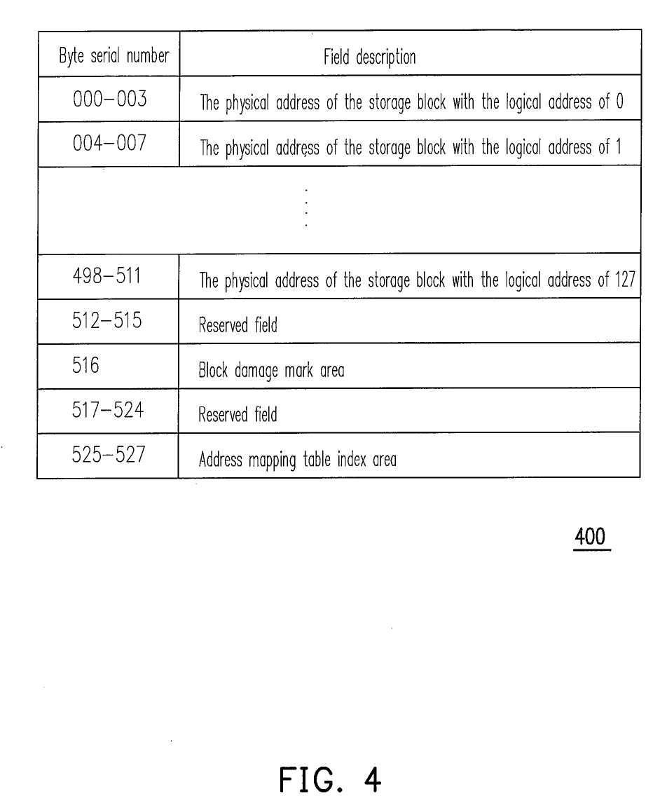

In the present embodiment, besides the storage blocks, the NAND flash further includes an address mapping table block for storing mapping relations of logical addresses and physical addresses of storage blocks within the NAND flash. FIG. 4 is a schematic diagram illustrating a page of an address mapping table block according to an embodiment of the present invention. In the present embodiment, 4 bytes are used for recording the physical address of each storage block. As shown in a second row of a page 400 illustrated in FIG. 4, a 0th byte to a third byte record a physical address of a storage block with a logical address of 0; as shown in a third row of the page 400, a fourth byte to a seventh byte record a physical address of a storage block with a logical address of 1. Deduced by analogy, the page 400 may record the physical addresses of 128 storage blocks. In an embodiment, if a next data to be read is located in a storage block with the logical address of 20, based on calculation, it is known that the physical address thereof is recorded to a 80th byte to a 83rd byte of the page 400. Besides the physical addresses are recorded, 16 bytes of a 512th byte to a 527th byte of the page 400 are respectively used for reservation fields, a block damage mark area and an address mapping table index area.

According to the address information recorded in the address storage unit and the address mapping table block, during read operation, the logical addresses are compared for judging whether or not the storage block storing the next data to be read is an adjacent storage block. If not, the physical address of the storage block storing the next data is then found according to the information stored in the address mapping table block. Though reading a certain page of the NAND flash takes a period of waiting time, if the next data to be read is stored in the adjacent storage block, the physical address of the adjacent storage block then may be quickly obtained according to the information recorded in the address storage unit. As to the NAND flash with the feature that that each time a large amount of continuous data is read, such information may surely increase the speed of reading of data.

In the present embodiment, the NAND flash is suitable for whole chip programming and is limited to have no support for random write operation. Namely, all the data to be written into the NAND flash are provided by the computer system and have to be written into the NAND flash in whole. Meanwhile, the computer system may also calculate information related to the addresses and write the information into a suitable field during data writing operation. Though the NAND flash of the present invention does not support the random write operation as that does of a conventional NAND flash, for those apparatus not requiring the function of the random write operation and having less requirement of data accessing efficiency, utilization of the NAND flash of the present invention may substantially reduce the hardware cost. Moreover, when the data is read, the required address information then may be obtained by simply looking up the table.

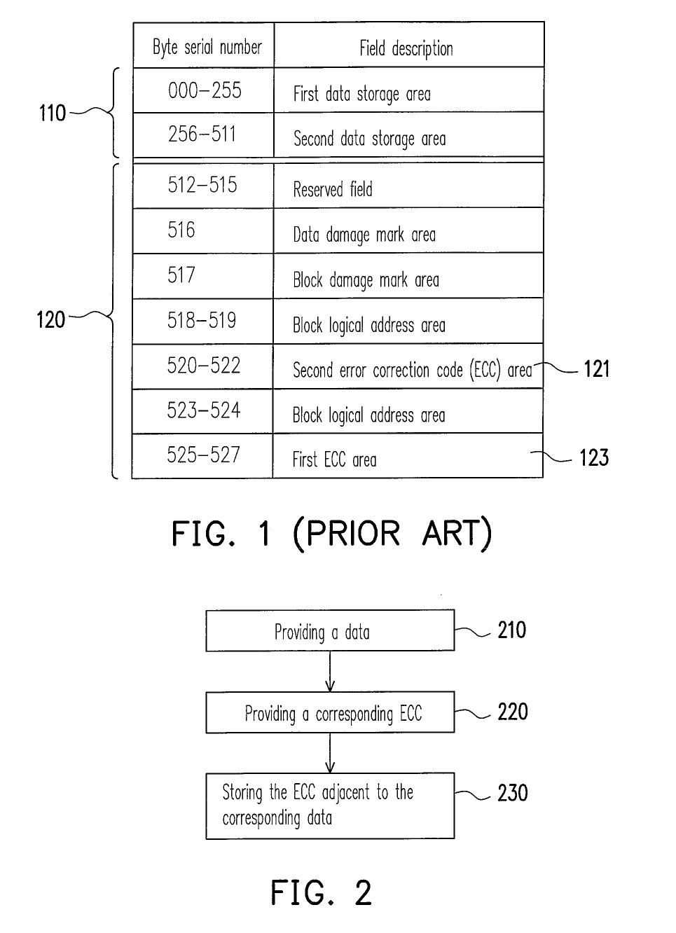

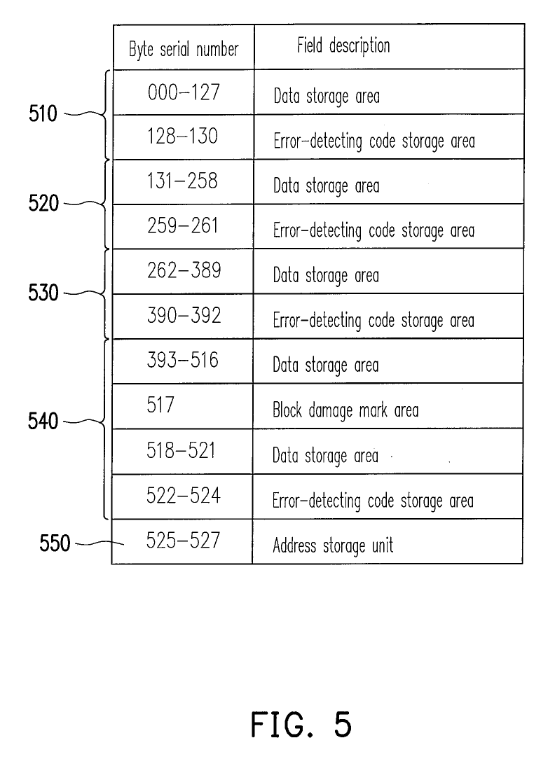

FIG. 5 is a schematic diagram illustrating an internal data configuration of a memory according to another embodiment of the present invention. In the present embodiment, assuming data storage volume of each page of the NAND flash is 521 bytes. Comparing FIG. 1 to FIG. 5, it is observed that both of the pages illustrated in FIG. 1 and FIG. 5 have a data storage volume of 512 bytes. However, in FIG. 5, a page space is divided into four areas, i.e. four data storage areas respectively in data storage units 510˜540. Moreover, in FIG. 1, the ECC used for checking correctness of the data is solely stored in the auxiliary space 120. However, in FIG. 5, the error-detecting code storage area used for storing the ECCs is located adjacent to the data storage area storing the corresponding data.

It should be noted that whether or not the blocks within the NAND flash are damaged is detected by corresponding manufacturer after fabrication of the NAND flash is completed, and a detection result thereof is recorded to a specific field (i.e. the block damage mark area with address thereof matches the predetermined byte serial numbers) of each page therein. To keep the block damage mark area to be located in the 517th byte as that does in the conventional NAND flash, in the present embodiment, the data storage area in the data storage unit 540 is divided to into two parts respectively located at 393rd byte to 516th byte and 518th byte to 521st byte, such that not only the 517th byte may be remained for storing the block damage mark, but also only the buffer space with 128 bytes is required when the data stored in the data storage unit 540 is read.

In the present embodiment, since the data and the corresponding ECC are adjacent to each other in the NAND flash after configuration, only a buffer space with a size matching the size of data storage area (i.e. 128 bytes) is required for temporarily storing the data during read operation, and then the ECC stored in the error-detecting code storage area may be read for checking the correctness of the data.

Accordingly, as to any type of the NAND flash developed according to an architecture (i.e. each page has 512 bytes data storage space and 16 bytes auxiliary space) shown as FIG. 1, regardless of how the volume of each page thereof is multiplied, as long as the volume of each page is multiple of 528 bytes (512 bytes plus 16 bytes), the NAND flash then may be configured according to the aforementioned memory configuration method, so as to configure the NAND flash into a plurality of the data storage unit, wherein each data storage unit includes a data storage area with the size of 128 bytes and adjacent error-detecting code storage areas. Namely, regardless of how the data storage space of each page of the NAND flash is multiplied, only 128 bytes buffer space is required for implementing error-detecting operation during data reading.

In summary, the memory and the configuration method thereof provided by the present invention have at least the following advantages:

1. Internal architecture of the NAND flash is re-configured for storing the data and the corresponding ECC adjacent to each other in the memory, such that the ECC may be immediately obtained when the data is read. Therefore, excessive buffer space is reduced, and cost of hardware is reduced accordingly.

2. Buffer space with relatively small volume may be applied for reading data from the NAND flash with different architectures, so that flexibility of the NAND flash is improved.

3. Extra storage space for recording the mapping relations between the logical addresses and the physical addresses of the storage blocks is unnecessary, and the mapping relations may be recorded in the NAND flash, so that cost of extra storage space is saved.

4. By recording the logical address of each storage block and the physical address of a storage block with an adjacent logical address, when the storage block with the adjacent logical address is continually read, the physical address of a next storage block then may be directly obtained, such that speed of inquiring the related physical address during data reading is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory configuration method, for a memory having at least a storage block, wherein each reading unit of the memory is capable of storing a plurality of data, the memory configuration method comprising:
providing an error correction code (ECC) corresponding to each of the data; and
storing each of the ECC adjoined to the corresponding data when the data is written into the memory.

2. The memory configuration method as claimed in claim 1, wherein size of each data matches a first predetermined value.

3. The memory configuration method as claimed in claim 1, wherein the step of providing the ECC corresponding to each of the data comprises performing a specific calculation to each of the data to generate the ECC with size thereof matching a second predetermined value.

4. The memory configuration method as claimed in claim 1 further comprising:
recording a mapping relation of a logical address and a physical address of each storage block into the memory.

5. The memory configuration method as claimed in claim 1 further comprising:
providing a first logical address corresponding to one of the storage blocks;
providing a physical address of a specific storage block, wherein a second logical address corresponding to the specific storage block is adjacent to the first logical address; and
recording the physical address to the memory.

6. The memory configuration method as claimed in claim 1 further comprising:
judging whether or not a second logical address of the storage block storing a second data is adjacent to a first logical address of the storage block storing a first data when two continuous data are read; and
providing a physical address recorded in the memory if the second logical address is adjacent to the first logical address, wherein the physical address corresponds to the second logical address.

7. The memory configuration method as claimed in claim 1 further comprising:
providing a predetermined byte serial number corresponding to each of the reading units; and
dividing the data and storing the divided data respectively into one of the reading unit if the address of storing the data comprises the predetermined byte serial number, so as to reserve an address corresponding to the predetermined byte serial number for storing a damage detection result of the reading unit.

8. The memory configuration method as claimed in claim 1, wherein the memory comprises an NAND flash memory.

9. A memory architecture, comprising:
at least a storage block, wherein each reading unit of each of the storage blocks comprises a plurality of data storage units, and each of the data storage units comprises:
a data storage area, for storing a data; and
an error-detecting code storage area, adjacent to the data storage area for storing an ECC corresponding to the data.

10. The memory architecture as claimed in claim 9, wherein size of the data storage area matches a first predetermined value.

11. The memory architecture as claimed in claim 9, wherein size of the error-detecting code storage area matches a second predetermined value, and the ECC is a calculation result of a specific calculation performed to the corresponding data.

12. The memory architecture as claimed in claim 9 further comprising an address mapping table block for recording a mapping relation of a logical address and a physical address of each of the storage blocks.

13. The memory architecture as claimed in claim 9, wherein each of the storage blocks further comprises an address storage unit for recording a physical address of a specific storage block, wherein a second logical address of the specific storage block is adjacent to a first logical address of the storage block.

14. The memory architecture as claimed in claim 9, wherein each of the reading units comprises a damage mark area, with an address thereof matching a predetermined byte serial number, for storing a damage detection result of the reading unit.

15. The memory architecture as claimed in claim 9, wherein the memory comprises a NAND flash memory.
